(19) United States
(12) Patent Application Publication
(10) Pub. No.: US 2026/0139545 A1
(43) Pub. Date: May 21, 2026

(54) CABINET WITH FACE FRAME HAVING A FRAMELESS CABINET APPEARANCE

(71) Applicant: Moshe Panzer, Brooklyn, NY (US)

(72) Inventor: Moshe Panzer, Brooklyn, NY (US)

(21) Appl. No.: 19/395,896

(22) Filed: Nov. 20, 2025

Related U.S. Application Data
(60) Provisional application No. 63/722,724, filed on Nov. 20, 2024.

(51) Int. Cl. E06B 5/00; A47B 55/00

(52) U.S. Cl. CPC E06B 5/006; A47B 55/00; A47B 2220/0072

(57) ABSTRACT

The cabinet comprises a face frame that has thinner vertical stiles than standard industry face frames but utilizes thicker side panels. This leave a larger margin between the side panels and the face frame so that the inner edges are flush, giving the cabinet a similar appearance to a frameless cabinet. Further, this construction allows hinges typically used with frameless cabinets to be used with the cabinet of the present invention. A first side of the hinge is coupled to the side panel and the second side of the hinge is coupled to the door. The construction of the cabinet box (minus the door and hinge) is the same as other framed cabinets so standard industry assembly techniques can be used to assemble the majority of the cabinet.

### CROSS-REFERENCE TO RELATED APPLICATIONS

This application claims priority to U.S. Provisional Application Ser. No. 63/722,724, filed Nov. 20, 2024, the entire contents of which are hereby incorporated by reference in their entirety.

### FIELD OF THE INVENTION

The present invention relates to a cabinet having a face frame that appears similar to a frameless cabinet appearance.

### BACKGROUND

Generally, cabinets (or other similar furniture with hinged doors) have a face frame that is much wider than the side frame for stabilizing the box of the cabinet. In such cabinets, one side of the hinge is generally coupled to the cabinet face frame, and the other side of the hinge is coupled to the interior of the cabinet door. In contrast, frameless cabinets utilize a different type of hinge type where one side is coupled directly to the side panel of the cabinet and the other side of the hinge is coupled to the door. However, frameless cabinets are generally more expensive to produce than cabinets with face frames because they require specialized equipment and more precise construction, leading to higher cost. Also, frameless cabinets generally must use more expensive materials to compensate for the lack of a face frame and often require professional assembly and installation. Therefore, a need exists for a cabinet having a face frame which has a similar appearance to a frameless cabinet without the aforementioned drawbacks.

### SUMMARY

The cabinet face frame of the present invention comprises a face frame that has thinner vertical stiles than standard industry face frames but utilizes thicker side panels. This leave a larger margin between the side panels and the frame so that the inner edges are flush, giving the cabinet a similar appearance to a frameless cabinet. Further, this construction allows hinges typically used with frameless cabinets to be used with the cabinet of the present invention. A first side of the hinge is coupled to the side panel and the second side of the hinge is coupled to the door. The construction of the cabinet box (minus the door and hinge) is the same as other framed cabinets so standard industry assembly techniques can be used to assemble the majority of the cabinet of the present invention. Thus, workers familiar with assembling standard industry cabinets with face frame would require little additional training to assemble the cabinet of the present invention, especially compared to the additional training required to produce and assemble frameless cabinets.

### BRIEF DESCRIPTION OF THE DRAWINGS

FIG. 1 depicts a top view of a standard industry cabinet.

FIGS. 2A and 2B depict enhanced views of the left and right vertical stiles of a standard industry cabinet.

FIG. 3 depicts an enhanced view of side panels of a standard industry cabinet.

FIG. 4 depicts an enhanced view of the margin between side panels and face frame of a standard industry cabinet.

FIGS. 5A and 5B depict enhanced view of a face frame of a standard industry cabinet.

FIG. 6 depicts an enhanced view of the connection between a cabinet door and face frame in a standard industry cabinet.

FIG. 7 depicts a hinge used in a standard industry cabinet in isolation.

FIG. 8 depicts the door positions of a standard industry cabinet having a left cabinet door and a right cabinet door.

FIG. 9 depicts a view of a frameless cabinet.

FIG. 10 depicts a top view of the cabinet of the present invention.

FIGS. 11A and 11B depict enhanced views of the face frame of the cabinet of the present invention.

FIG. 12 depicts an enhanced view of side panels of the cabinet of the present invention.

FIG. 13 depicts an enhanced view of the margin between side panels and face frame of the cabinet of the present invention.

FIGS. 14A and 14B depict enhanced views of the face frame of the cabinet of the present invention.

FIG. 15 depicts the cabinet of the present invention with a first cabinet door coupled to left side panel via a first hinge and a second cabinet door coupled to right side panel via a second hinge.

FIG. 16 depicts a view of a hinge used in the cabinet of the present invention in isolation.

FIG. 17 depicts the door positions of the cabinet of the present invention having a left cabinet door and a right cabinet door.

FIGS. 18A and 18B depict views of the cabinet of the present invention showing the inner edge of the face frame flush with the side panels.

FIG. 19-27 depict different exterior designs for cabinet doors and drawers compatible with the cabinet of the present invention.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

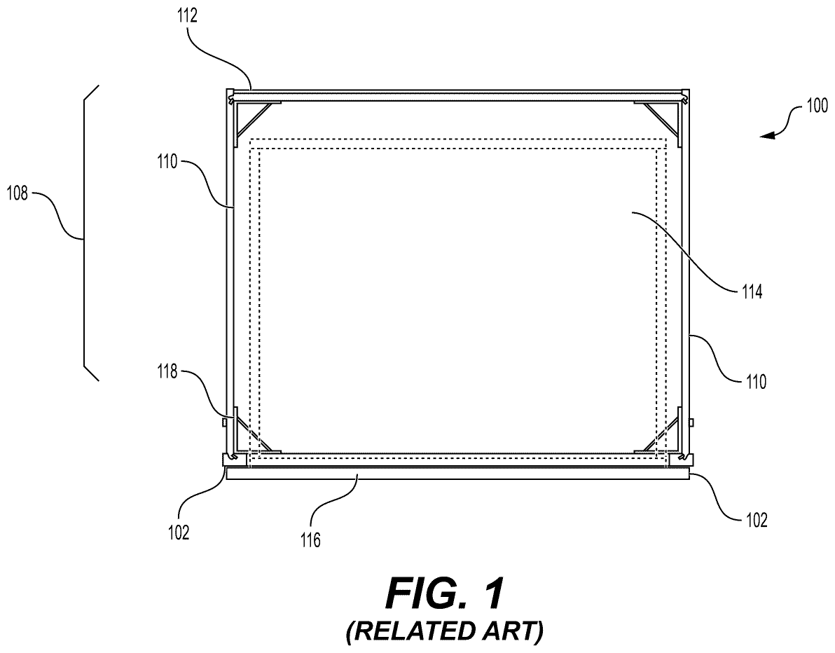

FIG. 1 depicts a top view of a standard industry cabinet 100. The vertical stiles 102 of the face frame 104 are generally 38 mm wide and the top and bottom stiles 106 are 38 mm wide. The cabinet box 108 generally comprises 12 mm thick side panels 110, a 17 mm total (12 mm+5 mm) thick back panel 112, and a 12 mm thick bottom panel 114. The side panels 110 may be double laminated side panels with a veneer (e.g., birch or other wood). The bottom panel 114 generally only has veneer on one side since the bottom of the cabinet is not visible, although double laminated panels may also be used (e.g., for kitchen cabinets). Similarly, the back panel 112 is a cold-pressed back panel that is single laminated but may also be double laminated. As shown, the face frame 104 is coupled to the cabinet box 108 using known techniques. The cabinet door 116 is coupled to the face frame 104 via a hinge. This leaves a 6 mm margin 118 between the side panels 110 and the face frame 104.

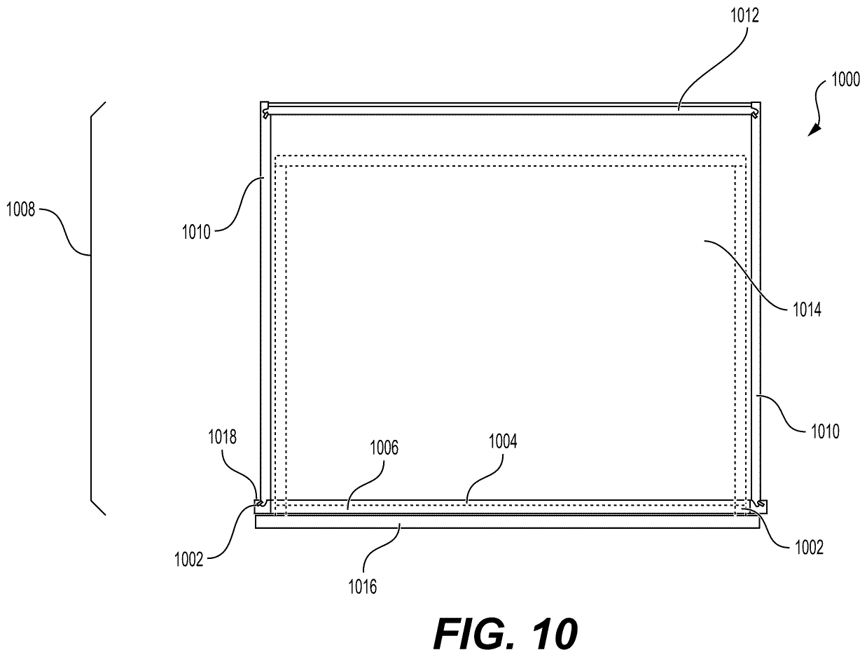

In contrast, FIG. 10 depicts a top view of the cabinet 1000 of the present invention. The vertical stiles 1002 of the face frame 1004 are generally 25 mm wide and the top and bottom stiles 1006 are 38 mm wide. The cabinet box 1008 generally comprises 15 mm thick side panels 1010, a 17 mm total (12 mm+5 mm) thick back panel 1012, and a 12 mm thick bottom panel 1014. The side panels 1010 may be double laminated side panels with a veneer (e.g., birch or other wood). The bottom panel 1014 generally only has veneer on one side since the bottom of the cabinet is not visible, although double laminated panels may also be used (e.g., for kitchen cabinets). Similarly, the back panel 1012 is a cold-pressed back panel that is single laminated but may also be double laminated. As shown, the face frame 1004 is coupled to the cabinet box 1008 using known techniques. The cabinet door 1016 is coupled to a side panel 1010 via a hinge. This leaves a 9 mm margin 1018 between the outer edge of the side panels 1010 and the outer edge of the face frame 1004, but the inner edges are flush unlike in cabinet 100.

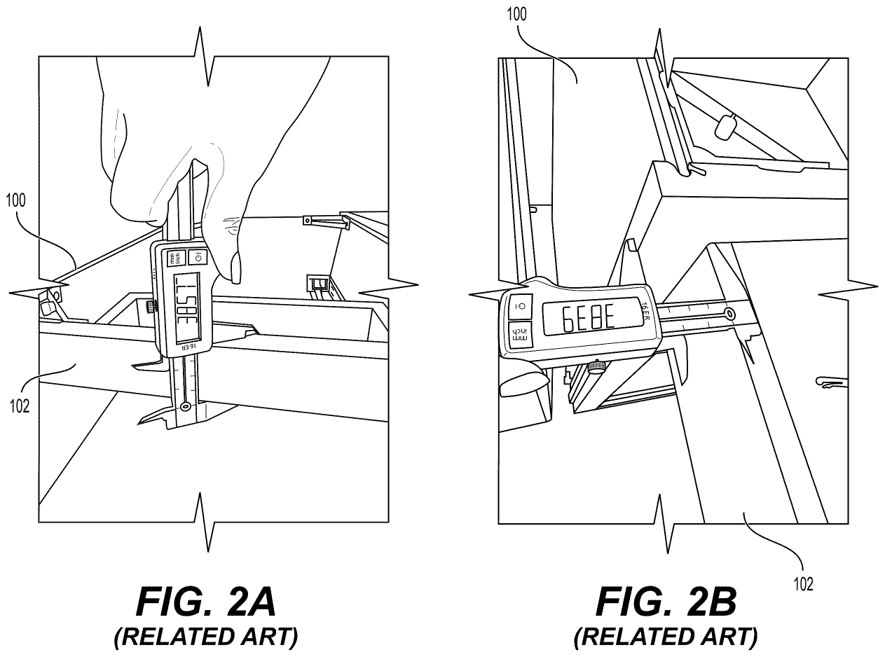

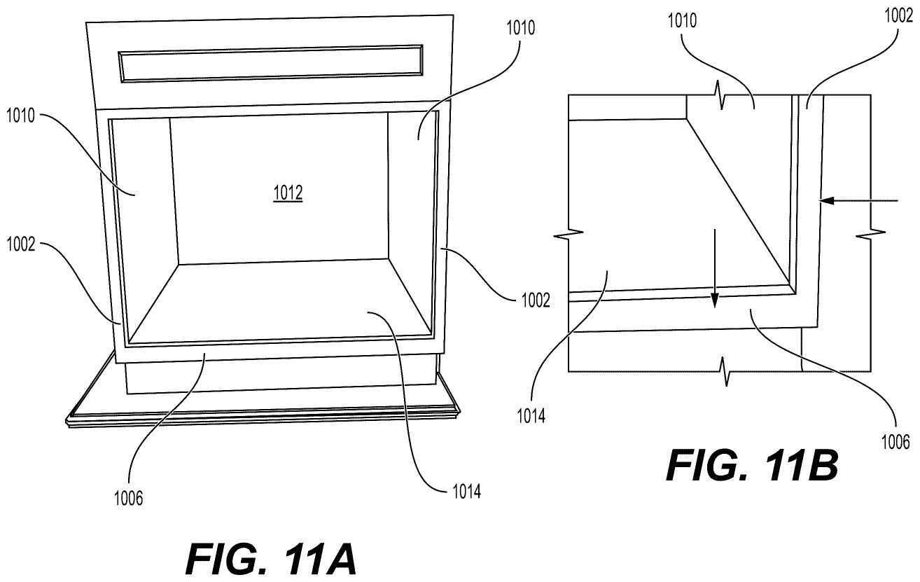

FIGS. 2A and 2B depict enhanced views of the left and right vertical stiles 102 of standard industry cabinet 100. In contrast, FIGS. 11A and 11B depict enhanced views of the face frame 1004 of cabinet 1000. Because the left and right vertical stiles 1002 are thinner than the top and bottom stiles 1006, the interior of face frame 1004 is flush with side panels 1010 and bottom panel 1014, giving cabinet 1000 a similar appearance to a frameless cabinet.

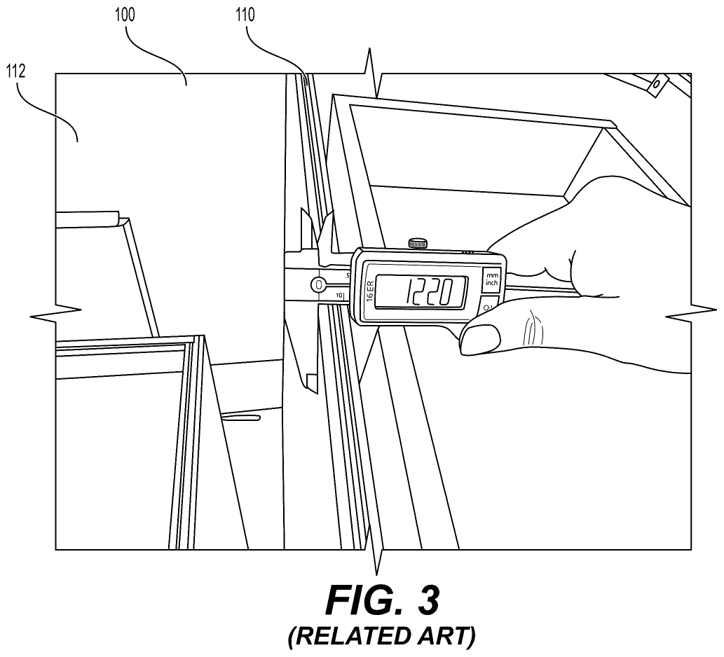

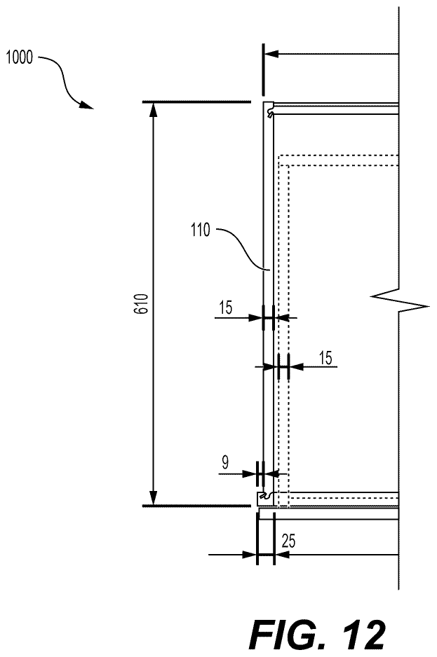

FIG. 3 depicts an enhanced view of side panels 110 of standard industry cabinet 100 which generally have a 12 mm thickness. In contrast, FIG. 12 depicts an enhanced view of side panel 110 which preferably have a thickness of 15 mm.

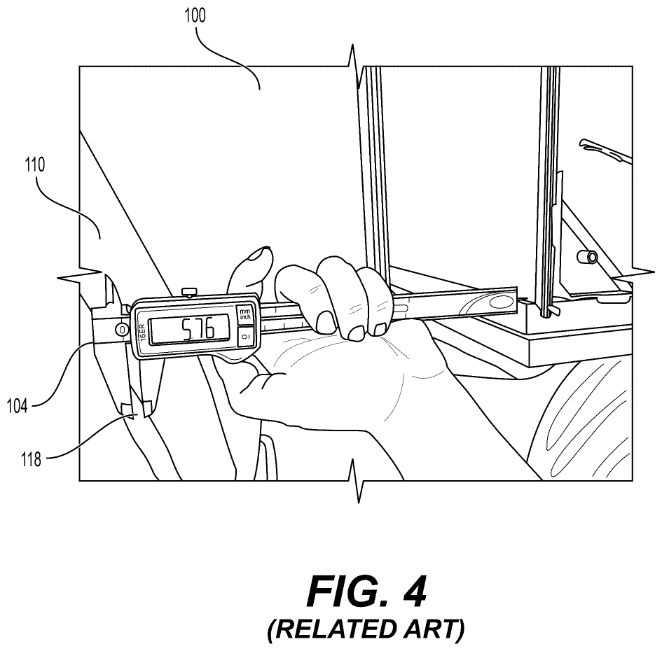

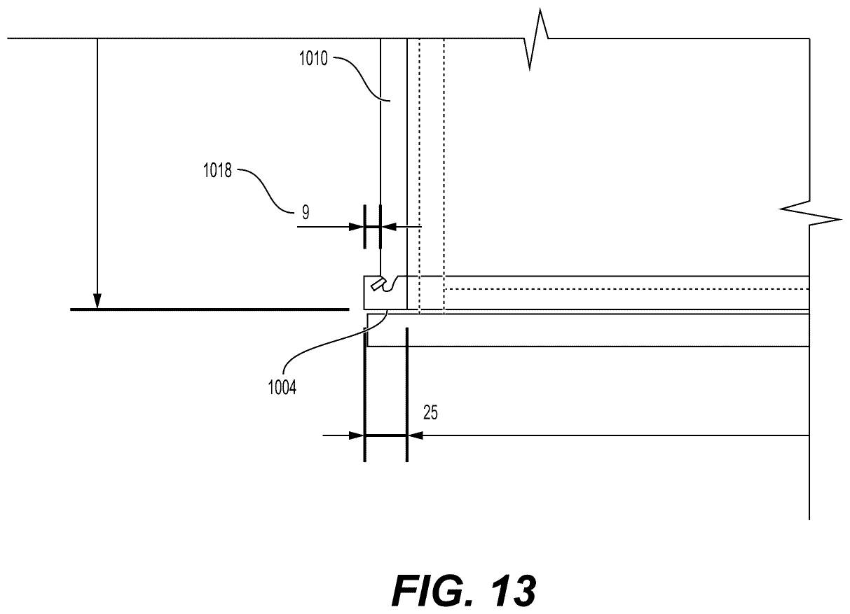

FIG. 4 depicts an enhanced view of margin 118 between side panel 110 and face frame 104. In contrast, FIG. 13 depicts an enhanced view of margin 1018 between side panel 1010 and face frame 1004. Margin 118 is generally 6 mm whereas margin 1018 is generally 9 mm.

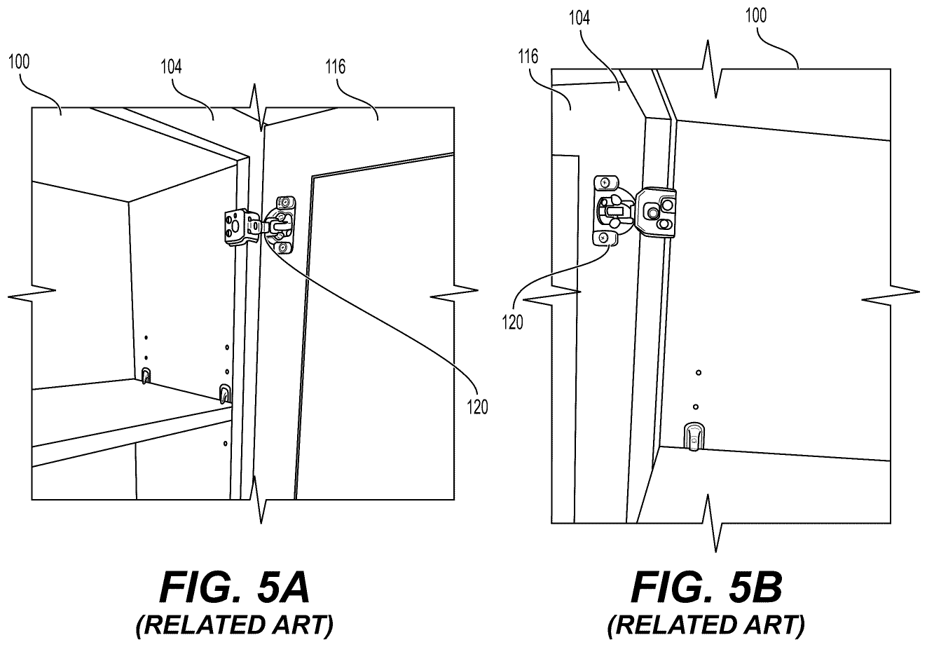

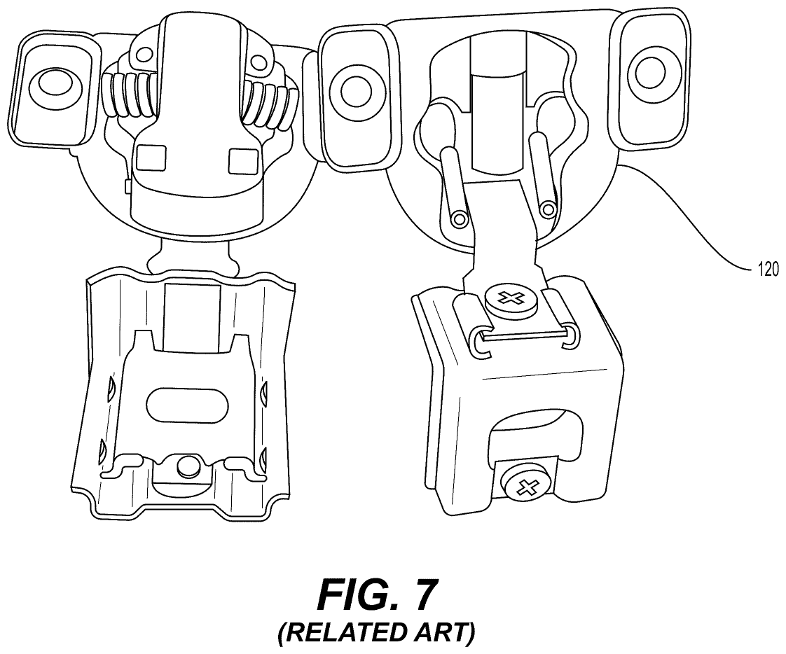

FIGS. 5A and 5B depict enhanced view of face frame 104. A first side of hinge 120 is coupled to face frame 104 and a second side of hinge 120 is coupled to cabinet door 116. The hinge 120, depicted in isolation in FIG. 7, may be a DTC 1¼″ six-way adjustable hinge typically used in frame cabinets 100. Because side panels 110 are only 12 mm thick in standard industry cabinet 100, the vertical stiles 102 are thicker to provide extra stability and the hinge 120 is coupled directly to face frame 104 instead of side panels 110.

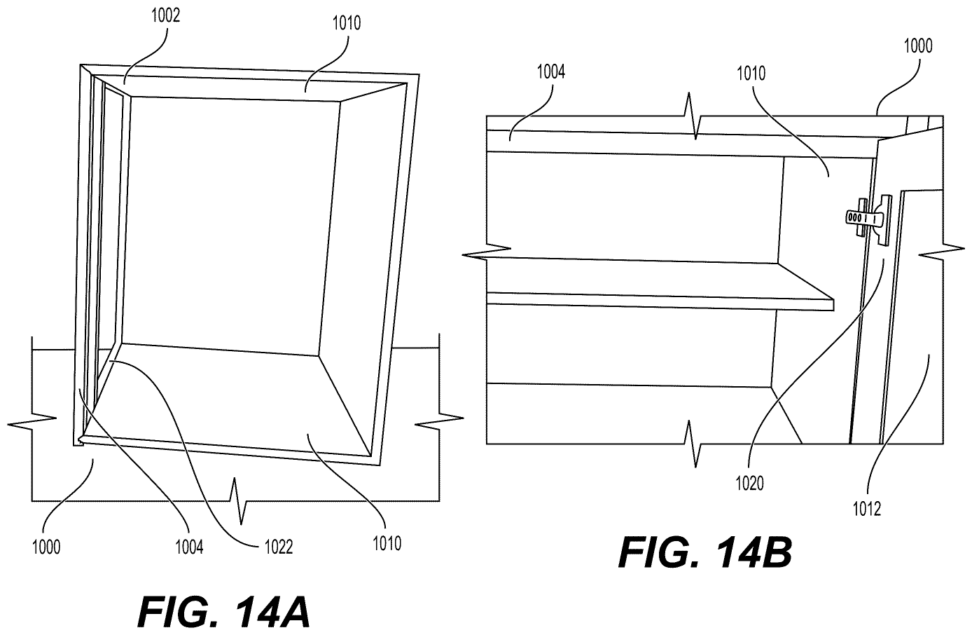

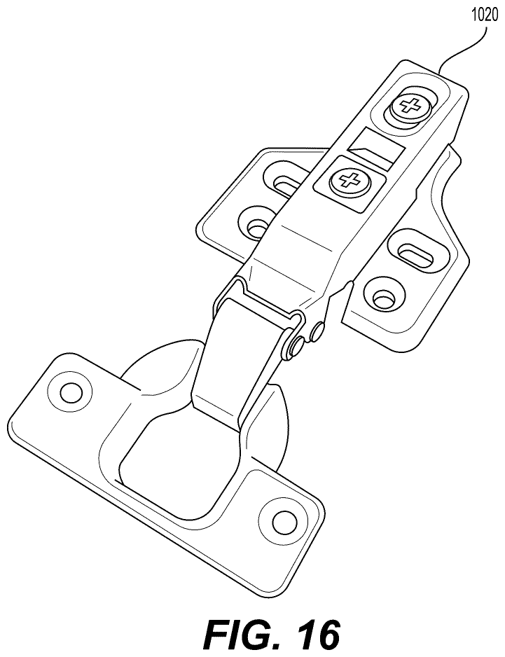

FIGS. 14A and 14B depict enhanced views of face frame 1004 of cabinet 1000. As previously described, vertical stiles 1002 are 25 mm in thickness and side panels 1010 are 15 mm in thickness, leaving a 9 mm margin 1018 between side panels 1010 and face frame 1004 and the inner edges are flush to give the appearance of a frameless cabinet. FIG. 14B depicts a first side of hinge 1020 coupled to cabinet door 1016 and a second side of hinge 1020 coupled directly to side panel 1010. The additional thickness of side panel 1010 compared to side panel 110 (15 mm vs 12 mm) allows hinge 1020 to be coupled to side panel 110 instead of face frame 1004. Frameless cabinets generally utilize 18 mm thick side panels so the reduction of thickness in side panels 1010 further allows less material to be used for side panels 1010. Because of the different connection points for hinge 1020, hinge 1020 is preferably the same type as those used in frameless cabinets. FIG. 16 depicts hinge 1020 in isolation which may be an Onus straight arm damping hinge 28.260.HM09 or any similar hinge used for frameless cabinets as is known in the art.

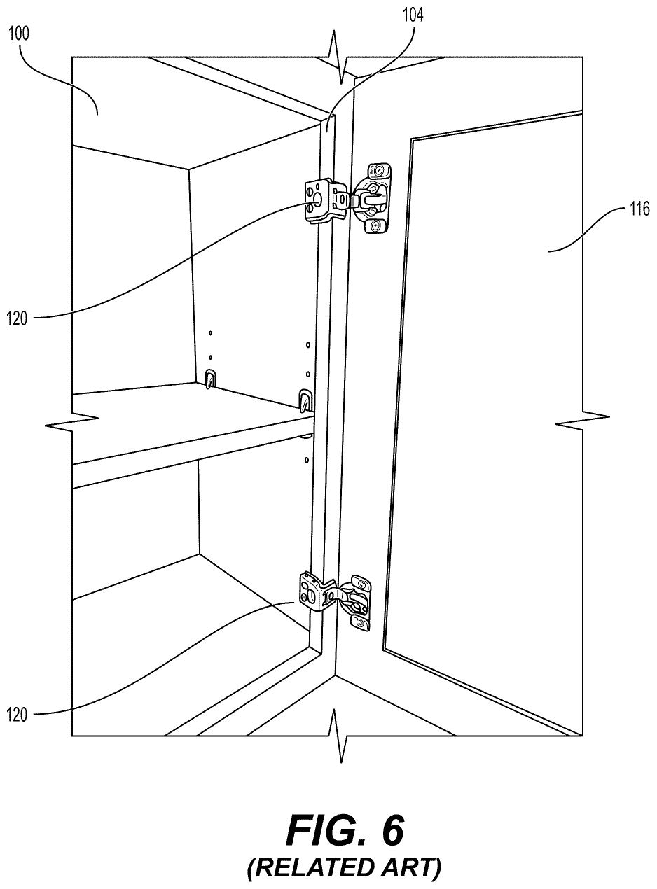

FIG. 6 depicts an enhanced view of the connection between cabinet door 116 and face frame 104 using hinge 120. Generally, two hinges 120 are utilized in standard industry cabinet 100, with a first hinge 120 being positioned near a top of cabinet door 116 and a second hinge being positioned near a bottom of cabinet door 116. For larger cabinet doors 116 or extra stability, additional hinges 120 may be utilized.

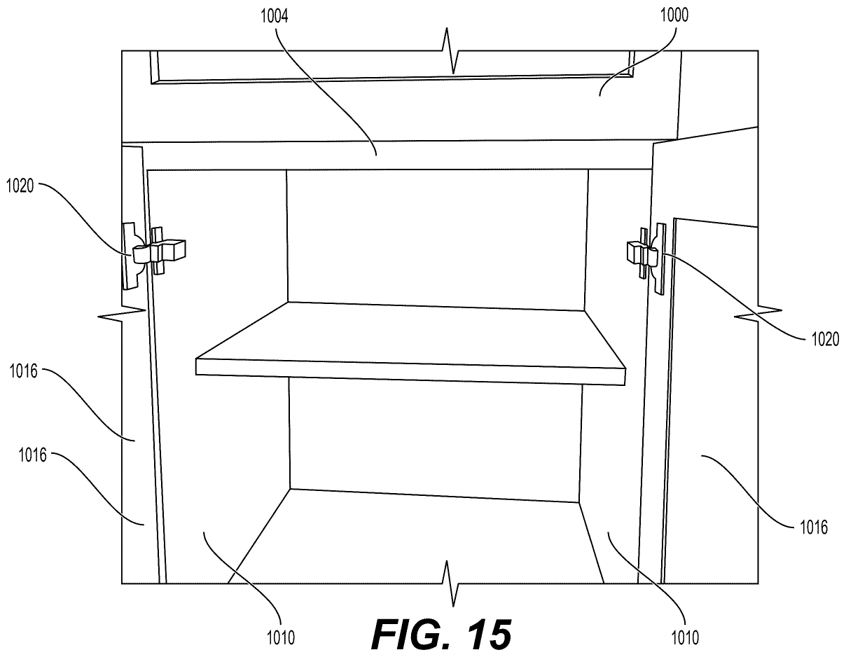

FIG. 15 depicts cabinet 1000 with a first cabinet door 1016 coupled to left side panel 1010 via a first hinge 1020 and a second cabinet door 1016 coupled to right side panel 1010 via a second hinge 1020 (lower hinges 1020 are not depicted).

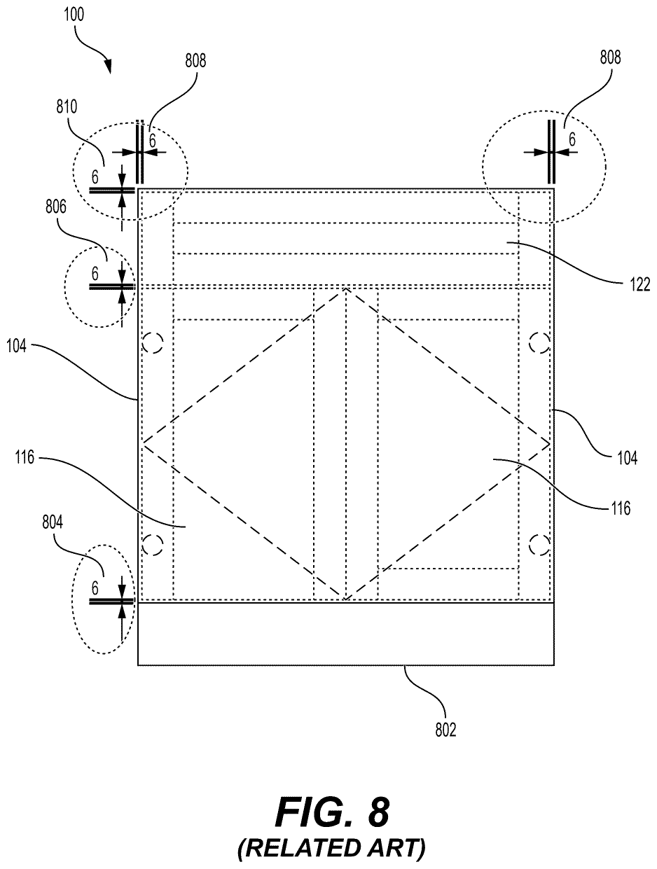

FIG. 8 depicts the door positions of a standard industry cabinet 100 having a left cabinet door 116 and a right cabinet door 116. A 2 mm gap 802 exists between inner edges of the cabinet doors 116 when in the closed position. The first hinge 120 is coupled to cabinet door 102 mm below a top of the left/right cabinet door 116 and a second hinge 120 is coupled to the cabinet door 102 mm above a bottom of the cabinet door 116. A 6 mm gap 804 exists between the bottom of cabinet doors 116 and the bottom of face frame 104. A 6 mm gap 806 exists between a top of cabinet doors 116 and drawer 122. When cabinet doors 116 are closed, a 6 mm gap 808 exists between an edge of the cabinet door 116 and an outer edge of the face frame 104. A 6 mm gap 810 exists between a top of drawer 122 and a top of face frame 104. Thus, approximately 6 mm of the face frame are visible surrounding both drawer 122 and cabinet doors 116 when they are in the closed positions.

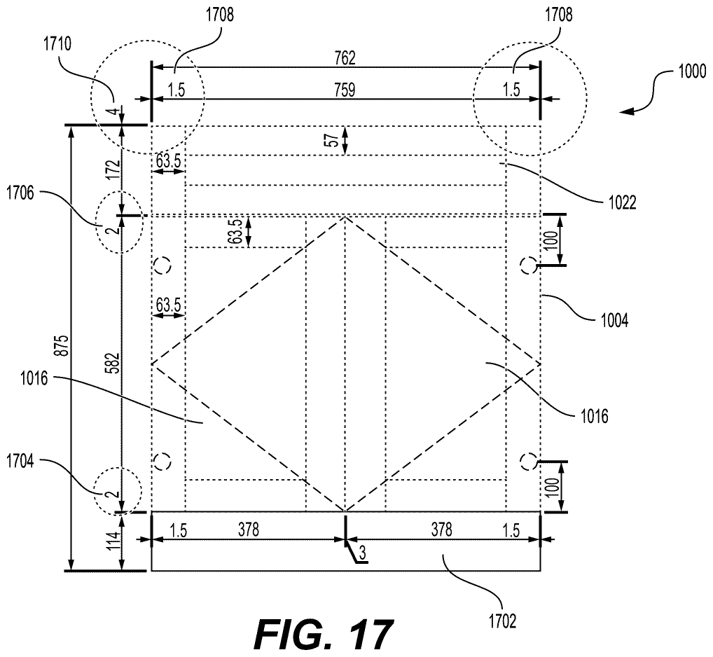

FIG. 17 depicts the door positions of cabinet 1000 having a left cabinet door 1016 and a right cabinet door 1016. A 3 mm gap 1702 exists between inner edges of the cabinet doors 116 when in the closed position. The first hinge 1020 is coupled to cabinet door 100 mm below a top of the left/right cabinet door 1016 and a second hinge 1020 is coupled to the cabinet door 100 mm above a bottom of the cabinet door 1016. A 2 mm gap 1704 exists between the bottom of cabinet doors 1016 and the bottom of face frame 1004. A 2 mm gap 1706 exists between a top of cabinet doors 1016 and drawer 1022. When cabinet doors 116 are closed, a 1.5 mm gap 1708 exists between an edge of the cabinet door 1016 and an outer edge of the face frame 1004. A 4 mm gap 1710 exists between a top of drawer 1022 and a top of face frame 1004. In general, the gaps between the face frame 1004 and cabinet doors 116 and drawer 1022 are much smaller than in standard industry cabinet 100, giving the front of cabinet 100 a cleaner overall appearance.

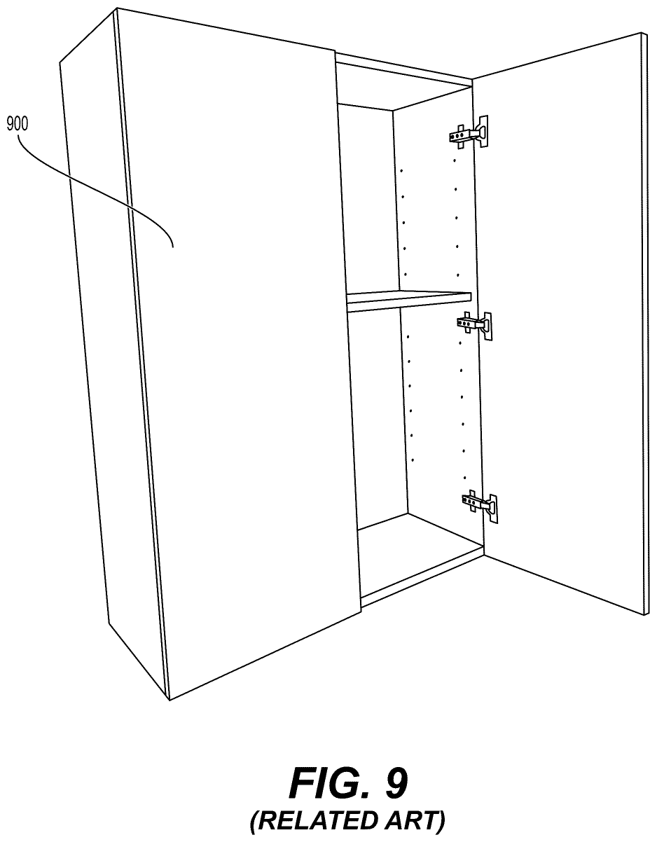

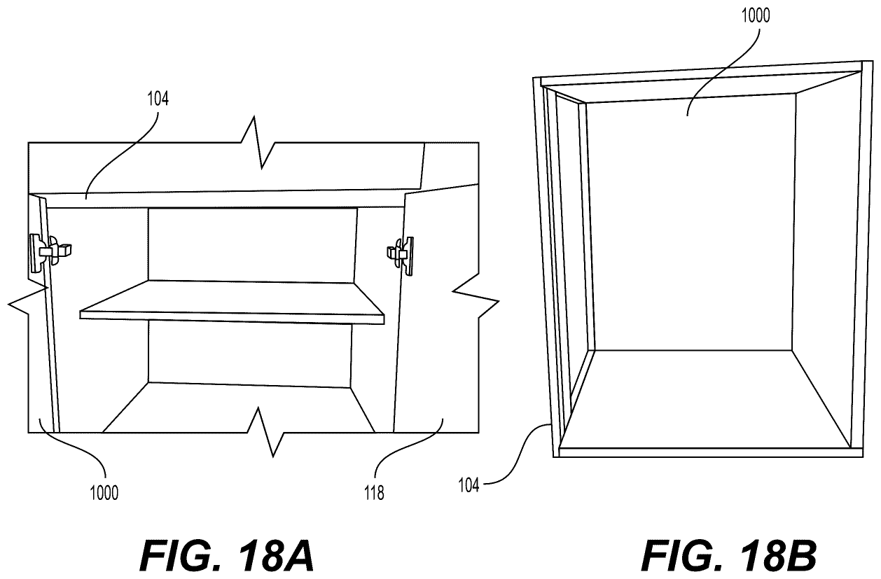

FIG. 9 depicts a view of a frameless cabinet 900 and FIGS. 18A and 18B depict views of cabinet 1000. As shown, both cabinets 900 and 1000 have a similar appearance when the cabinet doors are opened despite cabinet 1000 comprising face frame 1004 whereas cabinet 900 does not have any face frame.

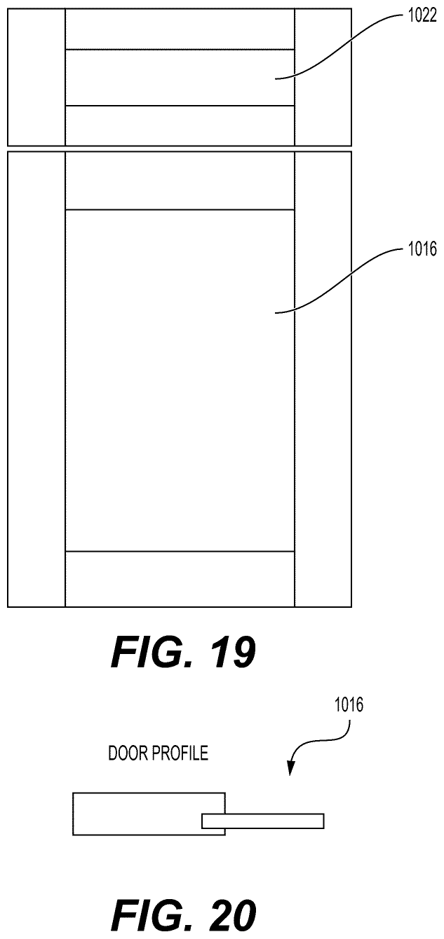

FIG. 19-27 depict different exterior designs for cabinet doors 1016 and drawer 1002. FIGS. 19-20 depict a Shaker style cabinet door 1016 and drawer 1022. Cabinet door 1016 has a 2 9/16″ inch stiles/rails with a recessed center panel and drawer 1022 has a five-piece recessed door front with 1½″ stiles/rails. In some embodiments, painted cabinet doors 116 have a wood frame and an MDF center panel while stained cabinet doors 116 have a wood frame and a veneer center panel. FIG. 20 depicts a profile of the cabinet door of FIG. 19 in which the stiles/rails have a thickness of ¾″ and the center stile has a thickness of ¼″.

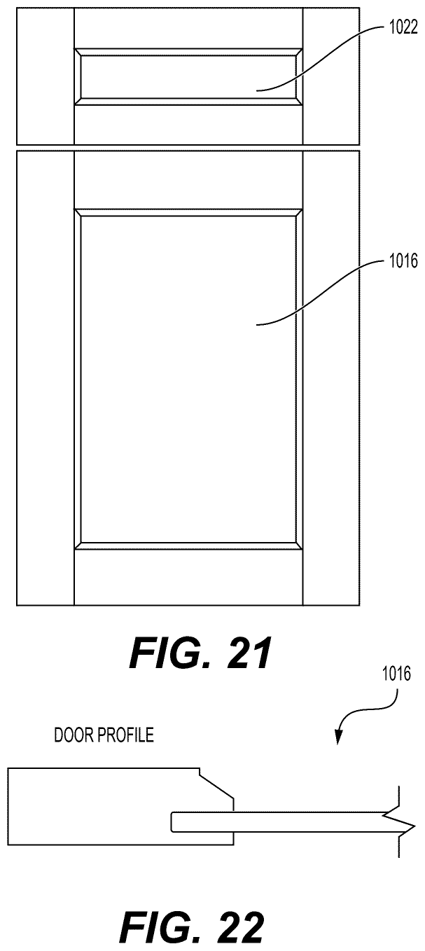

FIGS. 21-22 depict a Shaker Bevel style cabinet door 1016 and drawer 1022. Cabinet door 1016 has a 2 9/16″ inch stiles/rails with a recessed center panel and drawer 1022 has a five-piece recessed door front with 1½″ stiles/rails. In some embodiments, painted cabinet doors 116 have a wood frame and an MDF center panel while stained cabinet doors 116 have a wood frame and a veneer center panel. FIG. 20 depicts a profile of the cabinet door of FIG. 21 in which the stiles/rails have a thickness of ¾″ and the center stile has a thickness of ¼″. The bevel is approximately ¼″ in width and a height of ⅜″.

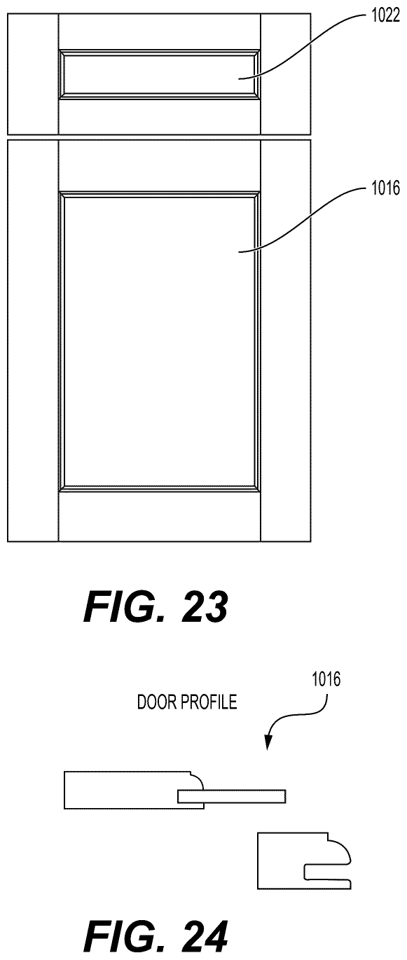

FIGS. 23-24 depict a Shaker Ogee Bevel style cabinet door 1016 and drawer 1022. Cabinet door 1016 has a 2 9/16″ inch stiles/rails with a recessed center panel and drawer 1022 has a five-piece recessed door front with 1½″ stiles/rails. In some embodiments, painted cabinet doors 116 have a wood frame and an MDF center panel while stained cabinet doors 116 have a wood frame and a veneer center panel. FIG. 20 depicts a profile of the cabinet door of FIG. 21 in which the stiles/rails have a thickness of ¾″ and the center stile has a thickness of ¼″. The bevel has a height of approximately ⅜″.

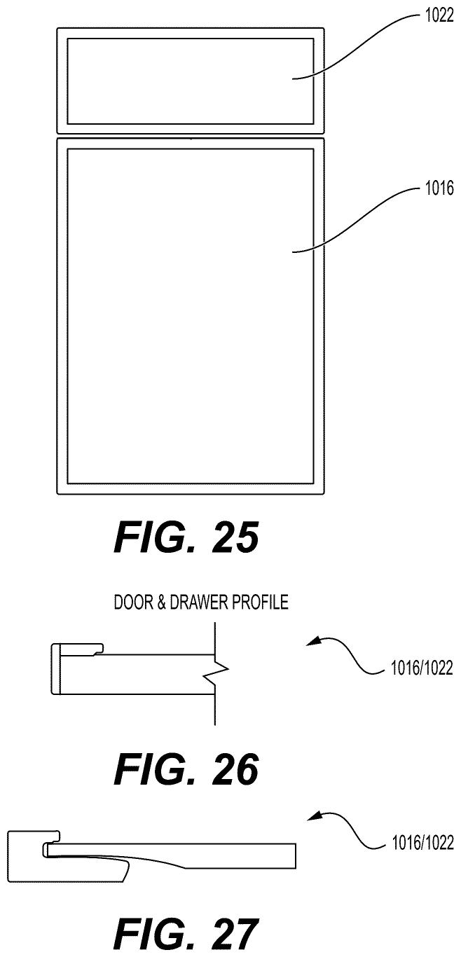

FIGS. 25-27 depict a Slim Shaker style cabinet door 1016 and drawer 1022. Cabinet door 1016 has an outer frame ⅝″ thick and drawer 1022 has an outer frame ⅝″ thick. The outer frame is preferably solid wood and the center is preferably MDF for both cabinet door 1016 and drawer 1022. FIG. 26 depicts a profile of the cabinet door/drawer of FIG. 25 for painted doors (with measurements) and FIG. 27 depicts a profile of the cabinet door/drawer of FIG. 25 for stained doors (with measurements).

While specific embodiments of the invention have been described above, it will be appreciated that the invention may be practiced other than as described. The embodiment(s) described, and references in the specification to “one embodiment,” “an embodiment,” “an example embodiment,” “some embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

1. A cabinet comprising:
a cabinet box,
wherein the cabinet box comprises:
a bottom panel;
a first side panel;
a second side panel; and
a top panel;
a face frame coupled to a front of the cabinet box,
wherein the face frame comprises:
a first vertical stile;
a second vertical stile;
a first horizontal stile; and
a second horizontal stile;
a cabinet door,
wherein an inner edge of the first vertical stile is flush with an inner edge of the first side panel, and
wherein an inner edge of the second vertical stile is flush with an inner edge of the second side panel; and
a hinge,
wherein a first wing of the hinge is coupled to a rear edge of the cabinet door, and
wherein a second wing of the hinge is coupled to an interior edge of the first side panel.

2. The cabinet according to claim 1,
wherein the hinge is a frameless cabinet hinge.

3. The cabinet according to claim 1,
wherein a width of the first vertical stile is less than a width of the first horizontal stile or the second horizontal stile.

4. The cabinet according to claim 1,
wherein a width of the first vertical stile is 25 mm, and
wherein a width of the first horizontal stile is 38 mm.

5. The cabinet according to claim 1,
wherein a thickness of the first side panel is greater than a thickness of the bottom panel or a thickness of the top panel.

6. The cabinet according to claim 1,
wherein a thickness of the first side panel is 15 mm, and
wherein a thickness of the bottom panel is 12 mm.

7. The cabinet according to claim 1, wherein a margin between an outer edge of the first side panel and an outer edge of the first vertical stile is 9 mm.

8. The cabinet according to claim 1, wherein an inner edge of the first horizontal stile is flush with an inner edge of the top panel.

9. The cabinet according to claim 8, wherein an inner edge of the second vertical stile is flush with an inner edge of the bottom panel.

10. The cabinet according to claim 1, wherein the cabinet box further comprises:
a back panel.

11. The cabinet according to claim 10, wherein a width of the back panel is 12 mm.
